(19) United States
(12) Patent Application Publication
(10) Pub. No.: US 2025/0100207 A1
(43) Pub. Date: Mar. 27, 2025

(54) DEVICE FOR THE MANUFACTURE OF AN UNCONSOLIDATED TEXTILE ELONGATE MEMBER

(71) Applicant: OLLOW, CANEJAN (FR)

(72) Inventors: Bertrand LAINE, SAINT AUBIN DU MEDOC (FR); Aymeric AZRAN, BLAGNAC (FR)

(21) Appl. No.: 18/710,792

(22) PCT Filed: Nov. 17, 2022
(86) PCT No.: PCT/EP2022/082313

§ 371 Date: Dec. 9, 2024

(30) Foreign Application Priority Data
Nov. 17, 2021 (FR) FR2112160

(51) Int. Cl. B29C 53/68; B29C 53/80; B29L 23/00

(52) U.S. Cl. CPC B29C 53/68; B29C 53/8016; B29C 53/8091; B29L 2023/00

(57) ABSTRACT

The invention relates to a device (1) for manufacturing an unconsolidated textile elongate member (11), the device comprising a frame (2) with a longitudinal main guide (3) in a direction X, said main guide (3) being attached to the frame (2) and two modules (4) arranged in series around the guide (3) in direction X, each module (4) comprising a feed ring (5) surrounding a section of the guide (3), feed means (6) arranged on the ring (5) and capable of feeding at least one ribbon (10) to the main guide (3) at a feed rate V1, each ribbon (10) being capable of winding around the main guide (3) or onto the upper layer of ribbon (10), and means (15) for driving the ring (5) which are capable of rotating the ring (5) at a speed of rotation V2.

### DESCRIPTION

The present invention relates to the technical field of devices for manufacturing an unconsolidated textile elongate member, as well as the associated manufacturing process and the unconsolidated textile elongate member obtained thereby.

In the above field, braiding methods are known to form elongate tubes in particular. In order to be used, these tubes are then consolidated to form composite tubes.

However, such processes are costly, cannot be manufactured in large quantities and are restrictive in terms of the tubular shape obtained thereby.

There are also machines for manufacturing composite tubes comprising different layers of ribbon arranged on top of each other, with one layer comprising a resin that mixes and interacts with the ribbons of the upper layers. These tubes have a rigid matrix and are not easily transformed.

The aim of the present invention is to overcome these disadvantages, and to manufacture an unconsolidated textile elongate member that can comprise large dimensions and be easily transformed.

To this end, the invention relates to a device for manufacturing an unconsolidated textile elongate member comprising:
a frame comprising a longitudinal main guide in a direction X, said main guide being attached to the frame, and
at least two modules arranged in series around the main guide in direction X, each module comprising:
a feed ring surrounding a section of the main guide,
feed means arranged on the ring and capable of feeding at least one ribbon to the main guide at an angle of between −90° and 90° to direction X and at a feed rate V1, each ribbon being capable of winding at least around the main guide or onto the upper layer of ribbon, and
means for driving the ring which are capable of rotating the ring around the main guide at a speed of rotation V2.

The use of means for feeding a ribbon around a main guide allows ribbons to be easily deployed in the same direction. Each module can thus deliver at least one ribbon in a given direction and the elongate member thus comprises several layers of ribbon, each layer comprising at least one ribbon arranged at a given angle. The upper layer is defined as the last layer applied.

The device according to the invention allows as many layers of ribbon to be superimposed as the number of modules used. The feed rate V1 corresponds to the feed rate of the textile member relative to the main guide of the device. The rate V1 is therefore substantially the same for each module of the device.

Such an elongate member obtained by the device according to the invention offers many advantages. The elongate member is thus unconsolidated and can therefore be easily cold-bent to give it a particular non- rectilinear shape. The elongate member can then be consolidated, for example, by transforming it in a compatible tool.

The ribbons are deposited towards the main guide at an angle strictly greater than −90° to direction X in which the textile member is fed and strictly less than 90° to direction X in which the textile member is fed.

For the purposes of the invention, a ribbon is said to be textile and therefore comprises fibers, for example unidirectional carbon fibers, which are dry fibers. A ribbon compatible with the invention is capable of wrapping around the main guide and comprises a structure that is sufficiently rigid to remain wrapped around the main guide.

A ribbon compatible with the invention can also be made of plastic, ceramic, metal, paper or mixtures of said materials, without this list being exhaustive. A ribbon compatible with the invention is thus defined as any material capable of forming around a main guide and resisting the forces inherent to the device according to the invention.

According to a particular embodiment, a ribbon can further comprise a matrix intended to solidify rapidly and a consolidated textile elongate member can be obtained with the device of the invention.

According to one embodiment of the invention, a ribbon formed of unidirectional fibers impregnated with a thermoplastic matrix is endowed with sufficient flexural rigidity to retain a coiled shape without the need to use a support.

Such ribbons enable the manufacture of a textile member comprising, notably, a first layer of ribbon oriented at an angle of 0° relative to the main guide of the device, this first ribbon layer being capable of sliding over said main guide attached to the frame and of driving the upper layers resting on the first.

One of the advantages of using such ribbons in the device is that the ribbons can be fed continuously thus ensuring continuous production. Furthermore, the resulting textile elongate member is sufficiently robust, and the main guide of the device is attached to the frame and is therefore not part of the resulting textile elongate member. In contrast to some existing devices, it is thus not necessary to implement a heating step to solidify the material in order to obtain a usable final member.

The resulting unconsolidated textile elongate member can be used directly; it is not an intermediate component. However, depending on certain intended uses, additional steps may be applied to the resulting elongate member in order to transform and/or consolidate it.

According to one feature of the invention, each module comprises independent power supply means. Thus, each module can distribute different types of ribbon. The type and dimensions of the ribbons may differ from one layer to the next.

According to another feature of the invention, the main longitudinal guide comprises a substantially circular or polygonal or even free-form cross-section. The resulting elongate member can thus be shaped like a tube or can have a more complex shape depending on the application.

According to yet another feature of the invention, the feed means comprise at least one ribbon dispenser arranged around the feed ring. The use of ribbon dispensers makes it easier to store and dispense ribbons to the main guide, with the dispenser(s) rotating around the main guide according to the speed of rotation of the feed ring.

According to one embodiment of the invention, the ribbon dispensers comprise means for pivoting on the feed ring. The use of pivoting means makes it possible to orient the dispensing of the ribbons towards the main guide and thus select an angle between −90° and 90° between the ribbon and the main guide. All ribbons of the same module have substantially the same angle with the main guide.

According to another embodiment of the invention, the ribbon dispensers comprise at least one guillotine capable of cutting at least one ribbon exiting a dispenser and a motorized element capable of feeding the ribbon to the main guide.

According to another embodiment of the invention, the ribbon dispensers comprise welding means, for example ultrasonic welding means, capable of welding a ribbon to a present layer or upper layer. Other welding means compatible with the type of ribbons used are possible within the scope of the invention. When the diameter or cross-section, if it is not a tube, of the elongate member varies, it is interesting to add or remove one or more ribbons, which is possible within the scope of the invention by virtue of the use of guillotine and/or welding means.

According to one embodiment of the invention, the device further comprises a pulling assist device capable of guiding the ribbons of the module(s).

The use of a pulling assist device facilitates the sliding of the different ribbon layers along the main guide. An example of a pulling assist device can be a system of at least one roller arranged downstream of the last module in a direction X. This roller or rollers exert(s) sufficient pressure to cause ribbon layers to slide over the main guide. Depending on the type of ribbons, this assist device can be removed during the manufacture of the textile member which, by virtue of its rigidity, can advance alone over the main guide. According to other embodiments, the type of ribbons does not require pulling assistance.

According to one embodiment the invention, the device further comprises a longitudinal secondary guide having a diameter or cross-section greater than the diameter or cross-section, if it is not a tube, of the main guide and capable of translating over the main guide. When the device is in operation, a secondary guide with a larger diameter or cross-section can be used to increase the diameter or cross-section, if it is not a tube, of the elongate member, with the ribbons being deposited on the secondary guide.

The main guide of the device according to the invention is attached to the frame and therefore does not form part of the resulting textile elongate member. Thus, unlike existing systems, the manufacturing device does not comprise a mandrel, making it easy to vary the diameter of the resulting textile member. Such methods do not exist for devices with mandrels and are explained hereinafter.

The invention also relates to a process of manufacturing an unconsolidated textile elongate member comprising the following steps:
Implementing feed means on each of the modules of the device according to the invention, said feed means comprising selected ribbons,
Configuring the feed rate V1 and speed of rotation V2 speed of each module and starting up each module,
Cutting the elongate member and/or exhausting the ribbons, and
Recovering the resulting elongate member.

The feed rate V1 corresponds to the feed rate of the textile member over the main guide. The feed rate V1 is therefore substantially the same for each module. The feed rate V1 and speed of rotation V2 of each module are linked, on the one hand, to the angle defined between the ribbon or ribbons fed by each module and the feed rate thereof.

Such feed means, combined with the type of compatible ribbons as described herein before, make it possible to feed the device continuously and thus to implement a continuous process for manufacturing unconsolidated textile elongate members. The resulting textile members can be used directly upon exiting the device. It should be noted that such a manufacturing process does not require a step of heating the ribbons or the resulting textile member in order to solidify it and use it directly.

According to one embodiment of the invention, the process further comprises a step of storing the elongate member wound around a storage reel. The process according to the invention makes it possible to manufacture an elongate member of considerable size, for example up to a kilometer, until the ribbon feed means are exhausted. Storing the elongate member on a reel at the output of the device facilitates handling.

According to one embodiment of the invention, the process further comprises the step of assisting ribbon pulling with the implementation of the pulling assist device. The pulling assist device is positioned downstream of the last module delivering the last layer of the textile member. An operator can, for example, guide each of the ribbon layers towards the pulling assist device which will then help slide the different layers over the main guide.

According to one embodiment of the invention, the storage reel is a pulling assist device for ribbons from the feed means of the modules of the manufacturing device.

According to one embodiment of the invention, the process further comprises the additional step of arranging a longitudinal secondary guide at the level of the first module and translating said secondary guide along direction X. The secondary guide makes it possible to enlarge the diameter or cross-section, if it is not a tube, of the elongate member being manufactured or to decrease the diameter or cross-section of the member if a first secondary guide has already been used.

According to one embodiment of the invention, the process further comprises a step of cold bending the resulting elongate member to a desired angle. One advantage of the manufacturing device is the possibility of cold bending the elongate member.

According to one embodiment of the invention, the process further comprises a step of varying the diameter or cross-section, if it is not a tube, of the elongate member. In addition to the secondary guide, other means can be used to enlarge or reduce the diameter or cross-section, if it is not a tube, of the elongate member. For example, it is possible to provide a certain orientation of the ribbons of each layer in anticipation of an additional final step to allow a variation in the diameter of the elongate member of up to 50% to be obtained.

The invention also relates to an unconsolidated textile elongate member obtained from the manufacturing device according to the invention.

Of course, the various features, variants and embodiments of the invention can be associated with one another according to various combinations insofar as they are not incompatible or exclusive of one another.

In addition, various other features of the invention will become apparent from the appended description given with reference to the drawings which illustrate non-limiting forms of embodiment of the invention and wherein:

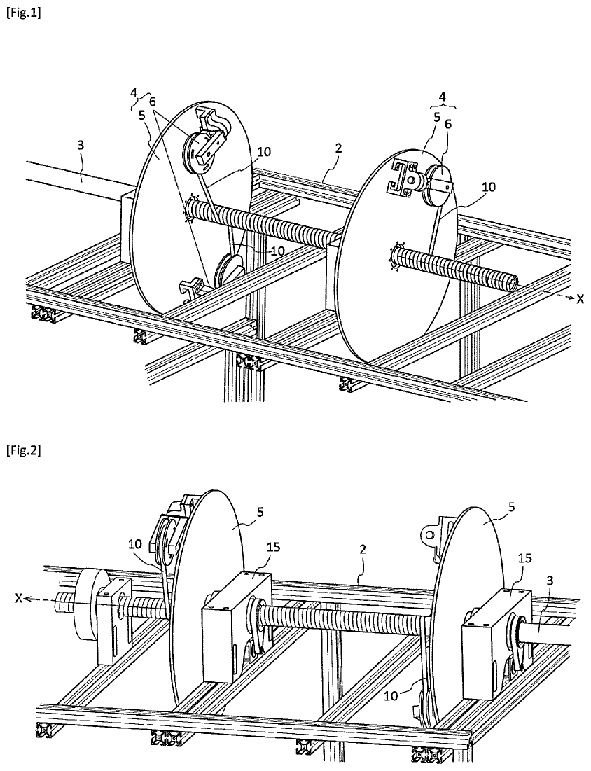

FIG. 1 is a perspective view of an example of the device according to the invention,

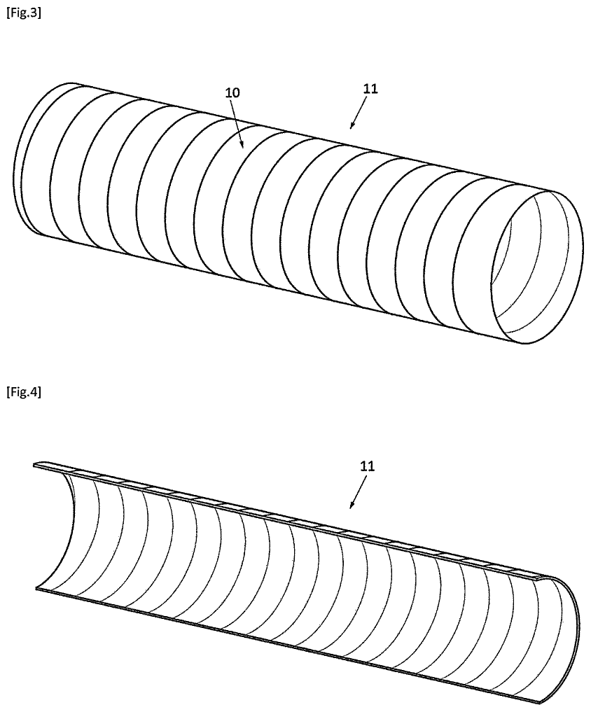

FIG. 2 is a perspective view from an opposite angle of the device shown in FIG. 1,

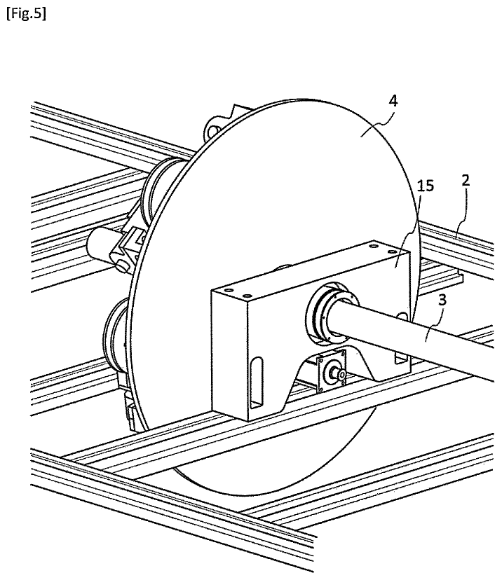

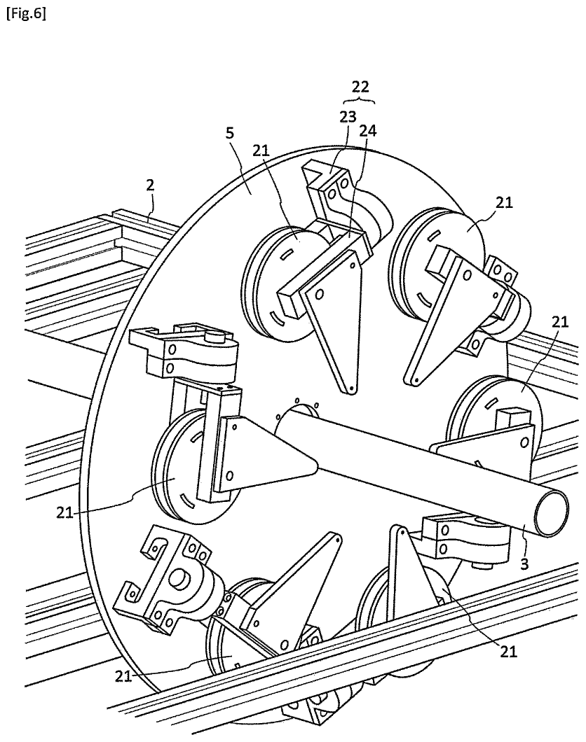

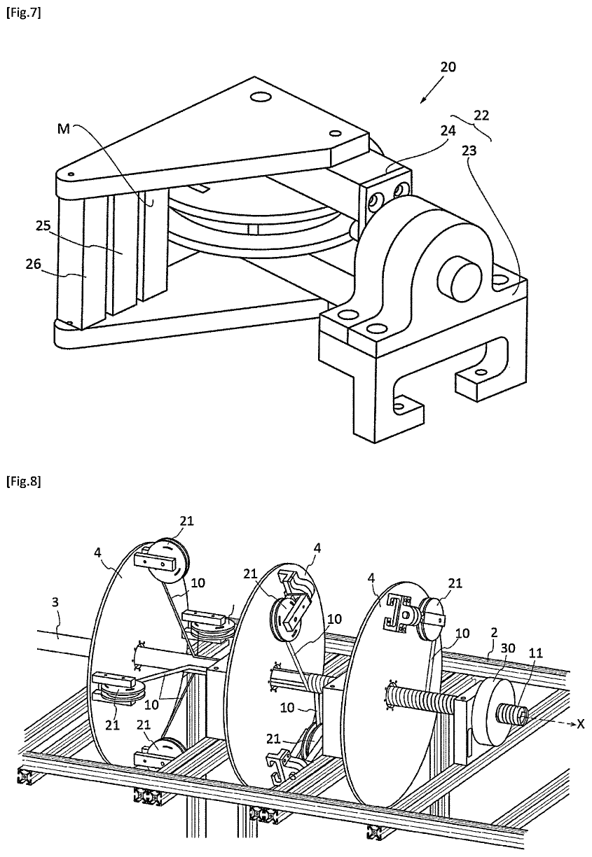

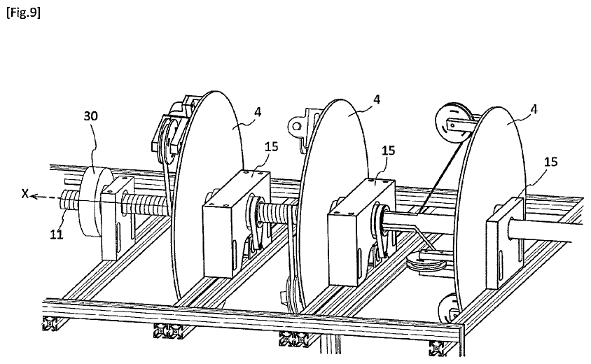

FIG. 3 is a perspective view of an example of an elongate member according to the invention,

FIG. 4 is a sectional view of FIG. 3,

FIG. 5 is a perspective view of an example of a module according to the invention,

FIG. 6 is a perspective view of the module shown in FIG. 3,

FIG. 7 is a perspective view of an example of a means of feeding the ribbon according to the invention,

FIG. 8 is a perspective view of another example embodiment of a device according to the invention,

FIG. 9 is a perspective view from an opposite angle of the device shown in FIG. 6,

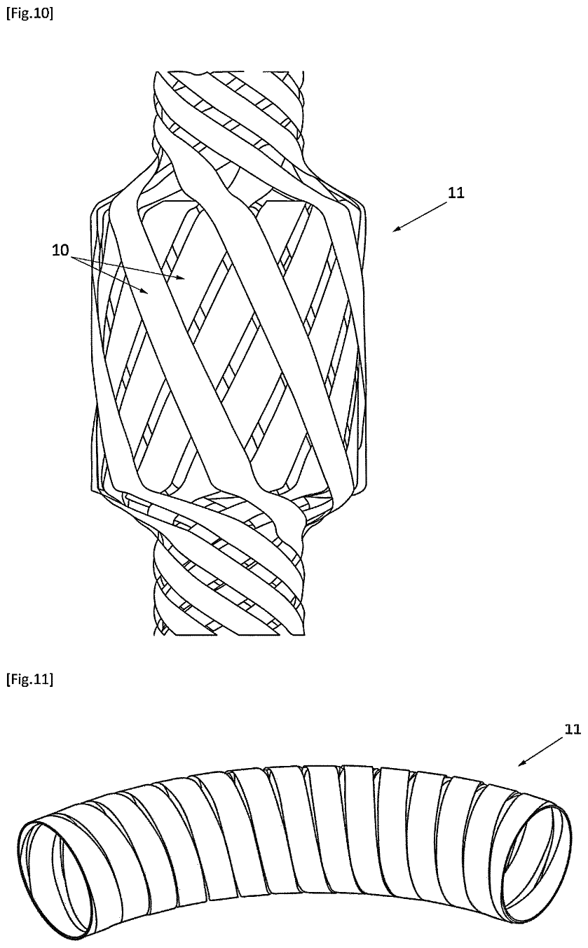

FIG. 10 is a perspective view of an elongate member comprising a variable cross-section according to the invention, and

FIG. 11 is a sectional view of a bent elongate member according to the invention.

It should be noted that in these figures, the structural and/or functional elements common to the different variants may have the same references.

A device according to the invention, as shown in FIGS. 1 and 2 and designated as a whole by the reference 1, is intended for the manufacture of an unconsolidated textile elongate member. To this end, the device 1 comprises a frame 2 comprising a longitudinal main guide 3 in a direction X, and at least two modules 4 arranged in series around the main guide 3 in direction X.

The main longitudinal guide 3 is attached to the frame 2. According to the embodiments shown, the main longitudinal guide 3 comprises a circular cross-section and is therefore tubular in shape. This shape is not limiting for the invention; other shapes of main guide 3 are compatible with the invention. The main guide 3 is rectilinear and can comprise sections of different shapes such as square, rectangular, quadrilateral, triangular, polygonal, round, oval or mixed and/or free-form.

A module 4 of a device 1 according to the invention comprises, on the one hand, a feed ring 5 surrounding a section of the longitudinal main guide 3. According to the examples shown, the feed ring 5 is substantially disc-shaped comprising a central hole in which the main guide 3 is located.

A module 4 comprises, on the other hand, feed means 6 arranged on the ring 5. According to the embodiment shown, the feed means 6 are located on one side of the disc and feed at least one ribbon 10 to the main guide 3 at an angle relative to direction X of between −90° and 90°.

A ribbon 10 compatible with the invention is, on the one hand, sufficiently flexible to wind around the main guide 3. FIG. 3 shows an elongate member 11 obtained by means of the device 1 according to the invention. It is the successive layers of ribbon 10 arranged at different angles that enable the resulting elongate member 11 to retain its shape. FIG. 4 shows a cross-section of this elongate member 11, wherein the successive layers are visible.

The feed means 6 arranged on the ring 5 feed at least one ribbon 10 to the main guide 3 at a selected angle between −90° and 90° relative to direction X. Each ribbon 10 is wound at least around the main guide 3 or onto the layer of ribbon 10 already present, that is the upper layer with a selected overall feed rate V1.

Each module 4 also comprises means 15 for driving the ring 5. According to FIG. 2 and also shown in FIG. 5, the drive means 15 are located on the side of the ring 5 opposite the feed means 6. The means 15 for driving the ring 5 rotate the ring 5 around the main guide 3 at a speed of rotation V2. According to the embodiment shown, the drive means 15 comprise a motor notably comprising a belt capable of rotating the ring 5 and a motor control unit in order to implement a rotation speed V2 of the ring 5. This configuration is not limiting for the invention.

The device shown in FIGS. 1 and 2 comprises two modules 4. The feed means 6 of the first module 4 comprise two dispensers 20 of ribbon 10 and the feed means 6 of the second module 4 comprise a single dispenser 20 of ribbon 10. The power supplies 6 for the various modules 4 are in fact independent of each other. Thus, each module 4 can deliver ribbons 10 of different types and a selected number of ribbons 10 per layer.

FIG. 6 shows a module 4 comprising six dispensers 20 of ribbon 10. The dispensers 20 of ribbon 10 are arranged around the feed ring 5. According to the embodiments shown, a dispenser 20 of ribbon 10 comprises a reel 21 attached to one side of the ring 5 with pivoting means 22. According to this non-limiting embodiment shown, the pivoting means 22 comprise a fixed part 23 and a pivoting part 24 directed towards the reel 21. The reel 21 is free to pivot in the pivoting part 24 and the pivoting part is free to pivot relative to the fixed part 23. Thus, the reel 21 can be arranged in a desired configuration and the pivoting means 22 can be locked in the desired arrangement of the dispenser 20.

FIG. 7 shows a particular embodiment of the invention wherein a dispenser 20 of ribbon 10 also comprises a guillotine 25 capable of cutting the ribbon 10 exiting the dispenser 20, a motor M capable of feeding the ribbon after cutting and ultrasonic welding means 26 capable of welding a ribbon 10 to a present layer of ribbon 10 or upper layer. The illustration of the motor M, the guillotine 25 and the welding means 26 is schematic on FIG. 7 and other embodiments are possible and notably with means to act on a ribbon 10 outside the dispenser 20.

FIGS. 8 and 9 show a particular embodiment of the invention. The device 1 comprises three modules 4. The first module 4 comprises four dispensers 20 of ribbon 10, each of which deposit a ribbon 10 in feed direction X, which means that the angle between the ribbon 10 and the main guide 3 has a value of 0 degrees. The second module 4 comprises two dispensers 20 of ribbon 10, and finally the third module 4 comprises a single dispenser 20 of ribbon 10. This embodiment is not limiting for the invention.

In order to manufacture an elongate member 11 according to the invention, a first step consists in implementing feed means 6 on each of the modules 4 of the device 1. To this end, according to the examples shown, reels 21 each comprising a selected ribbon 10 are arranged on each feed ring 5 of the device 1. Preferably, the reels deliver the same ribbon 10 per module and each module 4 can comprise reels of ribbon 10 of different types.

According to the example shown in FIGS. 8 and 9, the ribbons 10 used have a width of between 20 and 10 mm and a thickness of around 150 microns.

A second step in the process consists in configuring the feed rate V1 and the speed of rotation V2 of each of the modules 4. The precise coordinated configuration of these two values makes it possible to define a desired angle between the ribbon 10 and the main guide 3 for each feed means 6. This angle varies between −90 and 90°, excluding these two interval limits. For example, and according to the example of the device shown in FIGS. 8 and 9, a first layer of ribbon 10 is deposited at an angle close to 0° relative to direction X, a second layer of ribbon 10 is deposited at an angle of approximately 80° relative to direction X and a third layer is deposited at an angle close to −80° relative to direction X.

One configuration example consists in defining a feed rate V1 substantially equal to one meter per minute and a speed of rotation V2 of two modules 4, each dispensing a ribbon 10, substantially equal to 360 revolutions per minute. This example is not limiting for the invention.

The modules 4 are then started up.

Depending on the type of ribbons 10, a pulling assist device 30 is used to help pull the ribbons 10 of the various layers of the member 11. According to the embodiment shown in FIGS. 8 and 9, the first layer of ribbon 10 from the first module 4 slides over the main guide 3 through the other two modules 4 implemented. The ribbons 10 of the first layer can slide on their own if their type so allows, or with manual assistance. The ribbons 10 of the other layers are deposited on the previous layer and then pass through the pulling assist device 30. This assist device 30 is not always necessary for the process, but it can help the different layers to slide in a direction X, depending on the type of ribbons 10 used.

In a particular embodiment, notably with the first layer of ribbons arranged at an angle close to 0° with direction X, manual assistance is not necessarily required to advance said ribbons 10.

A first layer of ribbons 10 arranged at an angle of 0° to direction X relative to the frame 2 thus slides over the main longitudinal guide 3.

In another embodiment, once further layers of ribbon 10 have been superimposed on the first layer, the elongate member 11 can be manufactured unaided and the pulling assist device 30 is no longer required and can be removed. A transitional starting assistance period may be necessary if the type of ribbon 10 used does not allow the ribbon to deploy efficiently from its reel 21.

The elongate member 11 thus manufactured can be stored wound around a storage reel thus facilitating subsequent handling thereof. The elongate member 11 can also be cut to size as it is manufactured, in accordance with the additional steps described below, for example with increased or reduced dimensions.

In one embodiment (not shown), the storage reel is a pulling assist device for ribbons 10. Indeed, as it winds, the textile member 11 pulls the ribbons 10 forming it.

Once the elongate member 11 is the desired size, it can then be cut. Another way of completing the process is to wait for the ribbons 10 to run out.

One of the advantages of using the device 1 according to the invention in the process of manufacturing a textile elongate member 11 is that no step of increasing the temperature of the ribbons 10 and/or of the resulting textile elongate member 11 is necessary to obtain a usable solid textile elongate member 11. In fact there is no need to implement a transformation step.

The resulting unconsolidated textile elongate member 11 can then be recovered. Consolidation steps can then be applied thereto, for example a thermoforming step when the dimensions so permit. When consolidating the elongate member 11, it is also possible to vary the dimensions of the elongate member 11 slightly, notably the perimeter thereof, in the order of 10-20%.

As the textile elongate member 11 is made up of layers of ribbon 10, it is possible to provide for a particular organization of the orientations of the ribbons 10 of the same layer and of each layer, and of any gaps between said ribbons 10 of the same layer, in order to anticipate a variation in the perimeter of the textile elongate member 11 of up to 50%. In fact, each of the layers can be forced into an angular reorganization independently of each other, the length of the textile elongate member 11 being affected. An additional final step then constrains the elongate member 11, with each layer of ribbon 10 reoriented at a new angle, the ribbons of the same layer being moved closer together or further apart, with the different layers being able to slide over each other.

In a particular embodiment, a secondary longitudinal guide (not shown) is arranged at the level of the first module 4 during manufacture. This secondary guide, whose diameter or cross-section is greater than the diameter or cross-section of the main guide 3, is positioned upstream of the first module 4 and translates in the direction of manufacture of the elongate member 11. The ribbons 10 of the various modules 4 are then deposited on the secondary guide, and again on the main guide 3 after the secondary guide has passed. In this way, it is also possible to greatly increase the diameter or cross-section or even overall shape of the elongate member 11 during the manufacture thereof. An example of such an elongate member 11 obtained is shown in FIG. 10.

With an increased diameter or cross-section, ribbons 10 similar to the ribbons 10 fed by the corresponding module 4 can be added by virtue of ultrasonic welding means 26, thus filling any openings that might form due to the increased surface area of the elongate member 11. Such an example is shown in FIG. 10 with ribbons 10 added to the layer below the upper layer when increasing the diameter of the member 11 and ribbons 10 cut when decreasing the diameter of the member 11.

In a further embodiment of the invention, the elongate member 11 obtained by means of the device 1 is cold-bent to a desired angle such as the elongate member 11 that appears in FIG. 11. This cold bending step can be carried out by hand, if the bending rigidity of the resulting elongate member 11 so permits.

In a further embodiment not shown, the elongate member 11 can also be consolidated by integrating a solid matrix into one of the constituent layers of ribbon 10 thereof.

Of course, various other modifications can be made to the invention within the scope of the appended claims.

1. A device (1) for manufacturing an unconsolidated textile elongate member (11) comprising:
a frame (2) comprising a longitudinal main guide (3) in a direction X, said main guide (3) being attached to the frame (2), and
at least two modules (4) arranged in series around the main guide (3) in direction X, each module (4) comprising:
a feed ring (5) surrounding a section of the main guide (3),
feed means (6) arranged on the ring (5), capable of feeding at least one ribbon (10) to the guide (3) at an angle of between −90° and 90° to direction X and at a feed rate V1, each ribbon (10) being capable of winding at least around the guide (3) or onto the upper layer of ribbon (10), and
means for driving (15) the ring (5) which are capable of rotating the ring (5) around the main guide (3) at a speed of rotation V2.

2. The device (1) according to claim 1, wherein each module (4) comprises independent feed means (6).

3. The device (1) according to claim 1, wherein the longitudinal main guide (3) comprises a substantially circular or polygonal or even free-form cross-section.

4. The device (1) according to claim 1, wherein the feed means (6) comprise at least one dispenser (20) of ribbon (10) arranged around the feed ring (5).

5. The device (1) according to claim 4, wherein the dispensers (20) of ribbon (10) comprise means (22) for pivoting around the feed ring (5).

6. The device (1) according to claim 4 further comprising at least one guillotine (25) capable of cutting at least one ribbon (10) exiting a dispenser (20) and a motorized element (M) capable of feeding the ribbon (10) to the main guide (3).

7. The device (1) according to claim 1 further comprising welding means (26) capable of welding a ribbon (10) to an upper layer.

8. The device (1) according to claim 1, further comprising a pulling assist device (30) capable of guiding the ribbon(s) (10) from the feed means (6) of the module(s) (4).

9. The device (1) according to claim 1 further comprising a longitudinal secondary guide having a diameter or cross-section greater than the diameter or cross-section of the main guide (3) and capable of translating over the main guide (3).

10. A process of manufacturing an unconsolidated textile elongate member (11) comprising the following steps:
Implementing feed means (6) on each of the modules (4) of the device (1) according to claim 1, said feed means (6) comprising selected ribbons (10),
Configuring the feed rate V1 and speed of rotation V2 for each module (4) and starting up each module (4),
Cutting the elongate member (11) and/or exhausting the ribbons (10), and
Recovering the elongate member (11) obtained.

11. The manufacturing process according to claim 10 further comprising a step of storing the elongate member (11) wound around a storage reel.

12. The manufacturing process according to claim 10 further comprising a step of assisting a pulling of the ribbons (10) with implementation of a pulling assist device (30).

13. The manufacturing process according to claim 10 further comprising an additional step of arranging a longitudinal secondary guide at the level of the first module (4) and translating said secondary guide along direction X.

14. The manufacturing process according to claim 10 comprising a step of cold bending the resulting elongate member (11) to a desired angle.

15. The manufacturing process according to claim 10 comprising a step of varying the diameter or cross-section of the elongate member (11).

16. An unconsolidated textile elongate member (11) obtained from the manufacturing device (1) according to claim 1.
